(19) United States
(12) Patent Application Publication
(10) Pub. No.: US 2026/0298302 A1
(43) Pub. Date: Oct. 1, 2026

(54) COMPACT TORSIONAL SPRING SYSTEM

(71) Applicants: The Regents of the University of Michigan, Ann Arbor, MI (US); Massachusetts Institute of Technology, Cambridge, MA (US)

(72) Inventors: Zachary P. BONS, Ann Arbor, MI (US); Elliott J. ROUSE, Ann Arbor, MI (US); Luke MOONEY, Sudbury, MA (US); Gray C. THOMAS, Ann Arbor, MI (US)

(21) Appl. No.: 19/483,263

(22) PCT Filed: May 13, 2024
(86) PCT No.: PCT/US2024/029174

§ 371 Date: Nov. 11, 2025

Related U.S. Application Data
(60) Provisional application No. 63/465,586, filed on May 11, 2023.

(51) Int. Cl. F16F 1/02

(52) U.S. Cl. CPC F16F 1/027; F16F 2228/06; F16F 2232/02; F16F 2234/06; F16F 2236/08; F16F 2238/024

(57) ABSTRACT

A torsional spring includes cantilevered flexures extending radially inward from an outer ring to free ends configured to interface with a central hub. The flexures may be tapered and/or have a serpentine shape that can be optimized based on desired spring stiffness and packaging volume.

### GOVERNMENT FUNDING

This invention was made with government support under 1830338 and 2024237 awarded by the National Science Foundation. The government has certain rights in the invention.

### TECHNICAL FIELD

This disclosure is related to elastic springs and, in particular, to springs for use in human-centered robotic applications such as exoskeletons and prostheses.

### BACKGROUND

Springs are important building blocks for many engineering applications, including elastically storing energy and measuring force or torque. This combination of functions makes springs highly desirable in human-centered robotic applications such as wearable rehabilitation devices, exoskeletons, and prostheses. However, the added weight and complexity associated with incorporating springs in such mobile devices can result in difficult design trade-offs. One example is a series elastic actuator (SEA), in which a spring is used to operatively and elastically couple the output of an actuator transmission with a load. This design paradigm has notable benefits, including compliant interaction with the environment, torque feedback, energy storage, and improved shock tolerance. But it also comes with drawbacks, including force bandwidth reduction and the aforementioned increase in mass and complexity.

As applied in mobile robotic systems, spring designs have prioritized specific energy (energy storage per unit mass) and energy density (energy storage per unit volume). Previous torsional spring designs, including thin-walled tubes and cantilever beams, pose challenges in packaging and volume. Torsion tube springs with thin walls and long beam flexures with cam-rollers or hinges can be effective in low-stiffness applications, and their low weight results in high specific energy. However, to achieve useful stiffness ranges, their aspect ratio (e.g., length over diameter) must be considerable, resulting in relatively long, thin springs that are often impractical for robotic rotary joints due to packaging considerations. While other spring architectures have addressed this problem, they have suffered from other disadvantages. Some are limited to non-linear elastic behavior and/or increased complexity, while others are limited by the inability to provide the same stiffness profile in either rotational direction. Some supposed advancements in torsional spring design have been limited to a very small angular range of motion with an associated small torque capability, while others are only capable of high stiffness ranges that are not usually compatible with human-centered robotic applications.

### SUMMARY

Embodiments of a torsional spring include a ring and a cantilevered flexure extending radially inward from the ring to a free end. The free end is configured to follow a cam surface of a concentrically rotating hub to bend the flexure.

Embodiments of the torsional spring may include one or more of the following features in any technically feasible combination:
the free end has a bulbous shape;
the free end has a circular profile;
the flexure is one of a plurality of cantilevered flexures each extending radially inward from a ring to a respective free end configured to follow a respective cam surface of a concentrically rotating hub to bend each flexure;
the flexure is tapered;
the flexure has a serpentine shape;
the ring and flexure are monolithic;
a stiffness of the spring is linear;
a stiffness of the spring is the same in opposite directions of deflection; and/or
the spring is operable in an angular deflection range of greater than +5 degrees.

Embodiments of a spring system include a torsional spring including any combination of one or more of the above-listed features in any technically feasible combination. The spring system further includes a concentric hub configured to rotate with respect to the ring. The hub includes a body and a projection extending radially outward from the hub, and the projection includes the cam surface.

Embodiments of the spring system include one or more of the following features in any technically feasible combination:
the cantilevered flexure is one of a plurality of cantilevered flexures each extending radially inward from the ring to a respective free end;
the projection is one of a plurality of projections each extending radially outward from the body;
each projection has a cam surface, and each free end is configured to follow a respective cam surface when the hub rotates relative to the ring;
cam surfaces of an adjacent pair of the of the hub at least partially define a groove in the hub, and a free end of a cantilevered flexure is received in the groove;
cam surfaces of an adjacent pair of projections of the hub are non-parallel;
cam surfaces of the hub are symmetric with respect to a plane bisecting a groove of the hub; and/or
concentric first and second torsional springs according to claim 1 in a series arrangement.

Embodiments of a robot include a joint and a torsional spring or spring system including any combination of one or more of the above-listed features in any technically feasible combination. The spring transmits torque from an actuator to the joint. The robot may be a powered prosthesis in which the joint is an ankle joint or a knee joint.

Embodiments of a method include optimizing the shape a flexure of a torsional spring including any combination of one or more of the above-listed features in any technically feasible combination. The method includes iterative minimization of a curvature of the flexure and/or iterative maximization of a spacing between adjacent flexures of the spring. One or more of the following spring parameters may be provided as a constraint as part of the method: a dimension of the spring, a material property of a spring material, a spring stiffness, and a maximum design stress.

### BRIEF DESCRIPTION OF THE DRAWINGS

FIG. 1 is a perspective view of an embodiment of a spring system, including a torsional spring engaged with a central hub;

FIG. 2 is an enlarged view of a central portion of FIG. 1;

FIG. 3 is a front view of an embodiment of a portion of the spring system illustrating a free end of a spring flexure engaged with the central hub;

FIG. 4 illustrates the flexure and one of the projections of FIG. 3 at an equilibrium position;

FIG. 5 illustrates the flexure and projection of FIG. 4 with the hub rotated through a unit angle and the flexure translated along an approximated tip path;

FIG. 6 illustrates the flexure and projection of FIG. 5 with the hub rotated through another unit angle;

FIG. 7 illustrates the flexure and projection of FIG. 6 with the hub rotated through another unit angle;

FIG. 8 is an end view of the free end of a tapered flexure;

FIG. 9 is a front view of the flexure of FIG. 8;

FIG. 10 is an end view of the free end of a tapered serpentine flexure;

FIG. 11 is a front view of the flexure of FIG. 10;

FIG. 12 illustrates a user interface of an implementation of a spring geometry optimization tool;

FIG. 13 is a front view of a spring geometry with tapered non-serpentine flexures;

FIG. 14 is a front view of a spring geometry with tapered serpentine flexures;

FIG. 15 is a front view of a spring geometry in which the flexures have a higher serpentine factor in a smaller area than in FIGS. 13 and 14;

FIG. 16 is a front view of a spring geometry in which the number of serpentine flexures is higher than in FIGS. 14 and 15;

FIG. 17 includes torque-deflection curves for the spring geometries of FIGS. 13-16;

FIG. 18 is an enlarged view of a central portion of FIG. 17;

FIG. 19 illustrates the designed and measured specific energy of the spring geometries of FIGS. 13-16 alongside the specific energies of prior art springs;

FIG. 20 illustrates the designed and measured energy density of the spring geometries of FIGS. 13-16 alongside the energy densities of prior art springs;

FIG. 21 is an exploded view of a robotic device in the form of a powered knee-ankle prosthesis including embodiments of the torsional spring and spring system;

FIG. 22 is a cross-sectional view of a spring system with torsional springs in series; and

FIG. 23 is a flow chart illustrating a method of optimizing spring geometry.

### DESCRIPTION OF EMBODIMENTS

The torsional spring and spring system described below combine low stiffness capability with a compact form-factor and low mass. The disclosed spring can be configured to conveniently mate with conventional robotic transmission components, such as the timing belt pulley of a belt-drive transmission. The spring can be part of a two-piece spring system including a central hub that interacts with free ends of radial cantilevers of the spring. The spring can have a generally flat form factor and is therefore well-suited for use in robotic joints. A model has now been developed that imparts the spring with predictable behavior and permits customization of the spring with a characteristic serpentine factor and density factor as discussed below. This design methodology enables rapid adoption of an energy-efficient spring design and lays the foundation for widespread inclusion of springs in lightweight and compact technologies, including but not limited to wearable robotics.

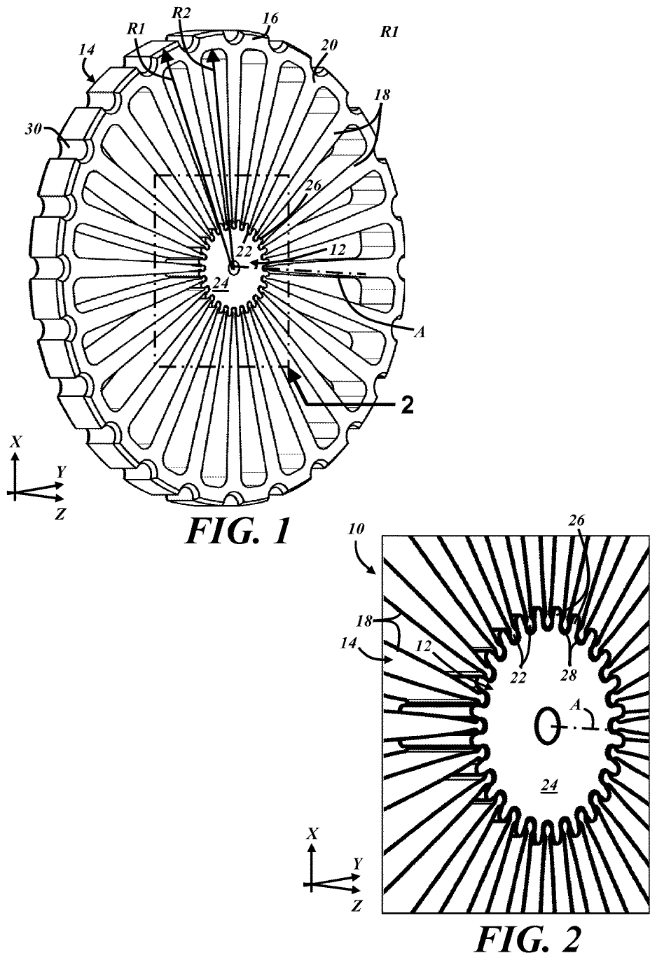

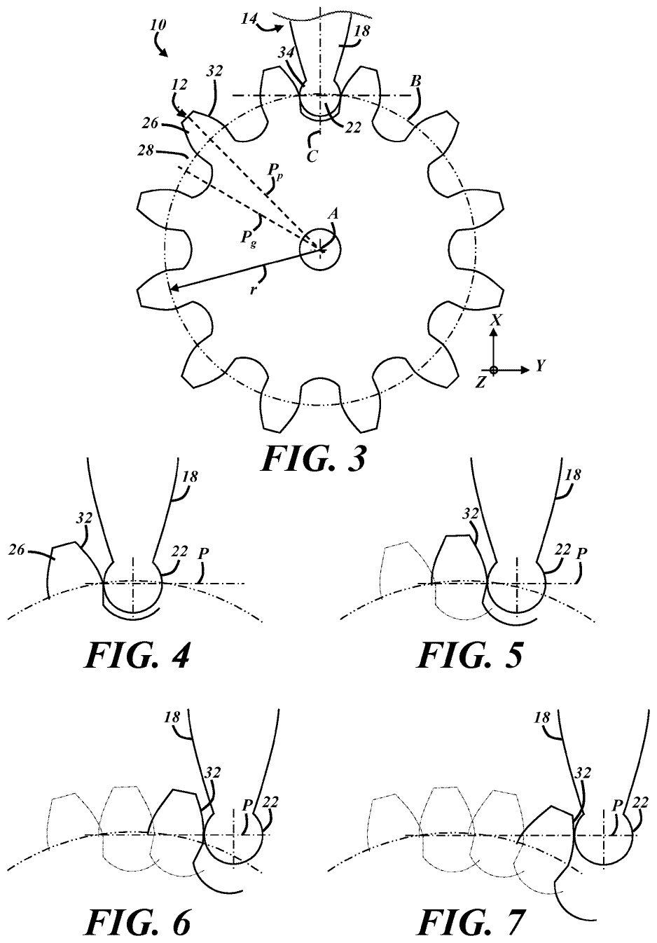

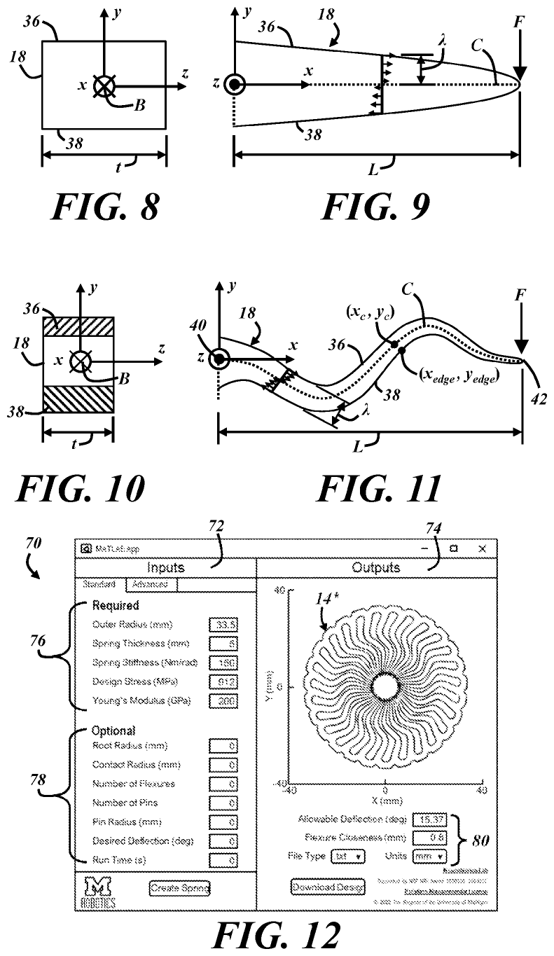

FIG. 1 is a perspective view of an embodiment of a spring system 10, and FIG. 2 is an enlarged view of a central portion of FIG. 1. The illustrated spring system 10 includes a central hub 12 and a coaxial torsional spring 14. The spring 14 is monolithic in this example and includes an outer ring 16 and a plurality of individual spring elements or flexures 18 extending radially inward from the outer ring. “Monolithic” means the spring 14 is formed as a molecularly continuous piece from a single material (e.g., a metal alloy). Each flexure 18 extends from a fixed end 20 at the ring 16 to a free end or tip 22. The free end 22 of each flexure 18 engages with the hub 12, which includes an annular or disc-shaped body 24 and a plurality of tooth-like projections 26 extending radially outward from the body. The flexures 18 and projections 26 may be equal in number, which is twenty-four in this case. Each flexure tip 22 is positioned or received in a corresponding groove 28 of the hub 12. Each groove 28 is defined between an adjacent or sequential pair of the outward projections 26. The arrangement of flexures 18 along the ring 16 and the arrangement of projections 26 along the hub body 24 are periodic with equal angular spacing (e.g., 15 degrees) among all adjacent pairs in this example. Relative rotation of the hub 12 and spring 14 about their common axis A causes each flexure 18 to bend in an X-Y plane in the manner of a cantilever beam. The resultant torque is a function of the angle of relative rotation between the hub 12 and ring 16 and is the sum of the individual torques associated with each individual flexure 18.

Although not shown in FIGS. 1 and 2, the spring system 10 may be coupled with a spring housing at the outer perimeter of the ring 16. The illustrated example includes notches or grooves 30 along the outer perimeter of the ring 16 that are configured to engage axially oriented pins at a fixed position along the housing. The grooves 30 may have an arcuate profile, for example, and the housing may include corresponding grooves with arcuate profiles along an inner perimeter such that dowels can be used to hold the spring 14 stationary with respect to the housing. In one manner of operation, the hub 12 rotates relative to the spring 14, thereby temporarily storing mechanical energy in each of the plurality of flexures 18. In an alternative arrangement, the spring 14 rotates relative to the hub 12.

FIG. 3 is a front view of an embodiment of the spring system 10 in which only the free end 22 of one of twelve flexures 18 is shown engaged with the central hub 12, which has twelve corresponding projections 26 and grooves 28. The hub 12 may also be referred to as a cam shaft, as the free end 22 of each flexure 18 is configured to follow a cam surface 32 of the hub to bend each flexure when the hub rotates relative to the spring 14. The free end 22 of each flexure 18 may be in the form of or may include a locally enlarged portion 34 that makes point contact along a line in the Z-direction with a cam surface 32 while following the cam surface during relative rotation of the hub 12 and spring 14. Here, and in the example of FIGS. 1 and 2, each flexure 18 is tapered to have a gradually reduced width as it extends from the ring 16 toward the hub 12. The locally enlarged portion 34 begins at an inflection point where the taper of the flexure ends and the width of the flexure 18 begins to increase with distance from the outer ring 16. With non-tapered flexures, the locally enlarged portion 34 may simply have a greater width than radially adjacent portions of the flexure. Here, the locally enlarged portion 34 has a bulbous shape and, specifically, has a circular profile in an X-Y plane. Other non-circular profiles are possible.

In the illustrated examples, each cam surface 32 is provided by one of the projections 26 of the hub 12, and each projection 26 has a pair of non-parallel cam surfaces 32 facing in opposite circumferential directions which are symmetric about a plane Pₚ bisecting the respective projection. Additionally, cam surfaces 32 of adjacent or sequential projections 26 oppose or face each other in opposite circumferential directions and at least partially define the groove 28 between the projections. These cam surfaces 32 of adjacent projections 26 are symmetric about a plane P_{g} bisecting the groove 28 they partly define. Along with symmetry of the locally enlarged portion 34 of each flexure 18, the symmetry among cam surfaces ensures that the spring 14 and spring system 10 exhibit a stiffness—i.e., a torque-angle relationship—that is the same in both rotational directions. Combined with symmetry in an X-Y plane along a centroid of each flexure 18, the spring 14 and spring system can exhibit a linear stiffness profile that is the same in both rotational directions.

The loading condition of the illustrated spring 14 and spring system 10 enables maximum strain of the bending flexures 18, which enables maximum energy storage in each flexure. For example, in a torsional spring system in which the central hub, outer ring, and flexures are all one monolith with the opposite ends of the flexures each fixed respectively at the hub and outer ring (e.g., in the manner of a spoked wheel), the system would be constrained to a strain rate that must be continuous as a function of spring radius. The relative motion between the hub 12 and spring 14 of the illustrated system 10 eliminates this potential constraint by providing one or more degrees of freedom at the free end 22 of each flexure 18. As described further below, the interface between the hub 12 and the spring 14 can be configured to approximate ideal bending, which is the most energy-efficient loading condition for bending beams.

The hub 12 is gear-like in appearance and shape, and the projections 26 are tooth-like and may be referred to as teeth. But the cam surface 32 may have a profile (i.e., its shape in an X-Y plane) that differs significantly from a conventional gear tooth. In particular, each cam surface 32 may have a profile shaped to approximate ideal bending of the associated flexures.

FIG. 3 illustrates the spring 14 and spring system 10 at its equilibrium or no-load condition, in which the free end 22 of each flexure 18 is centered within a respective groove 28 of the hub 12. At this relative position, the distance between the free end 22 of each flexure 18 and the spring axis A is at its minimum. A contact boundary B is also defined at this relative position, with each projection 26 having a contact portion on the radially outboard side of the boundary and a non-contact portion on the radially inboard side of the boundary. This boundary B lies at a contact radius r. Stated differently, if the hub 12 is rotated in either direction from the illustrated equilibrium position, the line of contact between each flexure 18 and associated projection 26 moves radially outward.

Ideal bending occurs when a pure moment is imposed along the full length of a beam. This condition can be approximated by applying a force to the free end of the beam, with the force being applied perpendicular to the neutral axis of the beam. Under this condition, the stress due to the force is small compared to the stress caused by the induced moment, and it therefore resembles a pure moment. To achieve an applied force that is nominally perpendicular to the length of each flexure, the shape of the cam surface can be defined as follows.

In the illustrated example, the free end 22 has a circular profile that slides along an involute cam profile 32. Derivation of the cam profile can be accomplished by approximating the path of the flexure tip 22 as parallel to the Y-axis of FIG. 3—that is, perpendicular to the equilibrium neutral axis C of the flexure 22—throughout the intended angular range of spring deflection, given the relatively small amount of X-movement of the free end 22 during bending of the relatively long flexure 18 (i.e., small angle approximation). A locus of points defining the cam surface 32 can be determined by iteratively resolving the necessary geometric constraints at multiple points along the approximated tip path P. FIG. 4 illustrates the flexure 18 and projection 26 at the equilibrium position of FIG. 3, and FIGS. 5-7, illustrate the flexure 18 at sequential positions along path P corresponding to a total range of about 40 degrees rotation of the hub 12. The necessary geometric constraints include tangency between the cam surface 32 and the profile of the flexure tip 22 and location of the contact point along the line of the tip path P. These constraints result in a cam surface 32 profile that is involute to the contact radius and ensures the prescribed perpendicular contact force.

As noted above, each flexure 18 may be tapered as it extends away from the outer ring 16 of the spring 14, as shown in FIGS. 1 and 2. The taper can help maximize the specific energy of the spring. With reference to FIGS. 8 and 9, the tapering law ensures that the entirety of the two bending surfaces 36, 38 of each flexure 18 reach the desired design stress at peak deflection. Consequently, a significant amount of material can be removed from a non-tapered beam, increasing the ratio of energy storage to mass. This tapering law governs the distance 2 from the neutral axis C to the bending surfaces 36, 38 as a function of the distance x along each flexure 18 from the fixed end and is derived from beam-bending mechanics. It is noted that the “x” and “y” of FIGS. 8 and 9 and in the equations below is related to a coordinate system for an individual flexure 18, which is distinct from the “X-Y” coordinate system of the spring 14 and spring system illustrated in the previous figures, although “z” and “Z” represent the thickness direction in both cases.

For a generic beam σ=Mλ/I, where σ as axial stress, M is applied moment (F(L−x)), and/is the second moment of area. In the case of a planar spring, I=2tλ³/3, with t (FIG. 8) as the thickness of the spring. To achieve maximum stress along the length of the flexure 18, λ is chosen at each cross-section such that σ=σ_{d}, the design stress:

$${σ}_{d} = \frac{3 F ( L - x ) λ}{2 t {λ}^{3}} . \qquad ( 1 )$$

Solving for λ:

$$λ ( x ) = \sqrt{\frac{3 F ( L - x )}{2 t {σ}_{d}}} . \qquad ( 2 )$$

The tapering law fully constrains the geometry of the flexure 18 and can be used to relate the spring rate of each flexure to its bending strain energy. By equating bending strain energy and the desired energy storage of each flexure, deflection behavior of the spring can be predicted.

Assuming that the interface of the flexure 18 with the cam surface 32 indeed approximates ideal bending, strain energy can be calculated. For a generic beam in bending, strain energy is defined by U=Mθ/2, where θ is beam deflection angle. Also, beam deflection angle θ=κL, where κ is curvature and can be expressed as κ=M/EI. Thus, U=M²L/2EI. For a varying beam profile with small deflections, strain energy can be rewritten as:

$$U = {\int }_{0}^{L} \frac{{{F}^{2} ( L - x )}^{2}}{2 EI} dx . \qquad ( 3 )$$

Substituting in for I and λ yields:

$$U = {\int }_{0}^{L} \frac{3 {{F}^{2} ( L - x )}^{2}}{4 Et {\sqrt{\frac{3 F ( L - x )}{2 t {σ}_{d}}}}^{3}} dx . \qquad ( 4 )$$

Rearranging and simplifying gives:

$$U = \frac{{σ}_{d}^{2} t}{3 E} {\int }_{0}^{L} \sqrt{\frac{3 F ( L - x )}{2 t {σ}_{d}}} dx , \qquad ( 5 )$$

which can be rewritten in closed form as:

$$U = \sqrt{\frac{2 {tFL}^{3} {σ}_{d}^{3}}{27 {E}^{2}}} . \qquad ( 6 )$$

Since force F is a function of stiffness k, desired deflection θ_{des}, the number of flexures n, and the flexure-cam surface contact radius r, this can be further simplified to:

$$U = \sqrt{\frac{2 tk {θ}_{des} {L}^{3} {σ}_{d}^{3}}{27 {E}^{2} rn}} . \qquad ( 7 )$$

The desired energy storage of a single flexure can be calculated by dividing the elastic potential of the full spring by the number of flexures:

$$ℰ = \frac{1}{2 n} k {θ}_{des}^{2} . \qquad ( 8 )$$

Equating the two expressions in equations (7) and (8) for energy storage within a flexure and solving for θ_{des} gives a prediction of the spring deflection as a function of spring design variables:

$${θ}_{des} = \sqrt[3]{\frac{8 {tnL}^{3} {σ}_{d}^{3}}{27 {E}^{2} kr}} . \qquad ( 9 )$$

Thus, while the tapering law characterizes mass-efficient straight flexures, specific stiffness (k), geometry (r, L, n, t), and material (E, σ_{d}) constraints directly limit the possible deflection of the spring as represented in equation (9). In addition, the energy density of the spring 14 is limited due to the necessary gaps between flexures 18 to accommodate deflection and the gear-like central hub 12.

To maximize energy density while maintaining high specific energy, it is possible to design serpentine-shaped flexures 18 that follow the tapering law, as illustrated in FIGS. 10 and 11. This results in flexures that are effectively longer and more massive than the straight flexures, yielding higher energy storage through increased flexure 18 deflection within the same outer diameter. A serpentine design also makes better use of the gaps between flexures 18, resulting in higher overall volume-efficiency compared to straight flexures.

To parameterize the design of serpentine flexures, equation (5) for strain energy is rewritten by substituting λ per equation (2):

$$U = \frac{1}{6} \frac{{σ}_{d}^{2}}{E} t ( 2 {\int }_{0}^{L} λ dx ) , \qquad ( 10 )$$

which can be further generalized to:

$$U = \frac{1}{6} \frac{{σ}_{d}^{2}}{E} tA . \qquad ( 11 )$$

Energy storage is thus a function of the planar area A of the flexures 18 such that energy storage is increased by increasing A. Equating desired energy storage from equation (8) with this updated expression for strain energy, the required planar area Aₛₑᵣₚ of a serpentine flexure 18 that achieves the desired peak deflection and torque is given as:

$${A}_{serp} = \frac{3 k {θ}_{des}^{2} E}{n {σ}_{d}^{2} t} . \qquad ( 12 )$$

Accordingly, knowing the required planar area Aₛₑᵣₚ and the governing taper profile, a serpentine flexure that satisfies the constraints can be defined. With this approach, spring deflection and stiffness can be prescribed independently, yielding increased design flexibility.

To aid in the classification of a spring 14 with such flexures 18, two novel design indices have been developed that provide an indication of the feasibility of a particular spring design. These novel design indices include a serpentine factor fₛ and a density factor f_{d}.

The serpentine factor is defined as fₛ=Aₛₑᵣₚ/Aₙₒₘ, where Aₙₒₘ is the planar area of equivalent straight flexures- and describes the sinuosity of a given flexure. If fₛ=1, then the desired spring will have straight flexures. If fₛ<1, the flexure is undefined and the diameter of the spring can be decreased while still maintaining the required deflection. Lastly, if fₛ>1, the flexures require a serpentine shape in order to achieve the desired performance.

The density factor is defined as f_{d}−Aₛₑᵣₚn/Aₐₙₙᵤₗᵤₛ, where n is the number of flexures 18 in the spring 14 and Aₐₙₙᵤₗᵤₛ is the annular (donut-shaped) area in which the flexures lie. This indicator describes the compactness of the flexures within the spring, where a value of f_{d}=1 would indicate that the spring 14 is a solid disk (i.e., all flexures 18 are touching), and a value of f_{d}=0 would represent a spring with no flexures. The density factor may have a practical maximum of approximately f_{d}=0.55, above which the flexures 18 begin to intersect.

Several other design parameters affect the energy storage potential of the spring 14, including number of flexures 18 and the flexure-cam surface contact radius. For instance, increasing the number of flexures 18 within the spring reduces the amount of empty space between adjacent flexures 18, even without a serpentine configuration, and thus increases energy density. Also, decreasing the contact radius makes space for longer flexures 18, thereby increasing energy density.

The direct relationship between these parameters and spring deflection is apparent in equation (9) where, even when all geometry and material parameters are fixed, increasing the number of flexures n further increases deflection and therefore energy storage. Similarly, decreasing the contact radius r directly improves deflection, and it also increases L (L=R−r, where R is the root radius) which again increases spring deflection. Practical limitations typically govern the possible number of flexures and a feasible contact radius (e.g., nearness constraints of flexure tips). Therefore, proper selection of these parameters can greatly enhance spring performance.

Where the spring 14 includes tapered flexures 18 and the spring-hub interface is configured to approximate ideal bending, the spring system has high specific energy. Selecting an optimal number of flexures 18 and imposing a serpentine geometry increases the energy density.

Since serpentine geometries have many degrees of freedom and physical characteristics that can be varied, it is useful to use an algorithm with which a computer can perform iterations to automatically optimize the flexures to remove the burden of geometry selection from the user. A software tool has been developed that can quickly generate one of the many spring profiles that meet desired specifications. The approach is based on nonlinear optimization that is constrained to achieve the target planar flexure area (among other requirements) and lowers the barrier to entry for devices with custom elastic elements. The tool can be implemented as a MATLAB® application and can generate output files that can be loaded into complete computer aided design (CAD) packages as a 2D-sketch component from which the solid body of the spring can be extruded in a single operation.

The primary objective of the optimization is to achieve a spring flexure 18 that has the desired serpentine factor fₛ and thickness profile, thereby meeting the performance requirements of the spring. Spring design is parameterized such that the planar area—and thus the serpentine factor, stiffness, and total stored energy—can be adjusted by the constrained nonlinear optimization without increasing the packaging volume of the spring 14. Since the serpentine geometry has many degrees of freedom, the optimization is underdefined without secondary objectives. Thus, the optimization includes constraints that align with the assumptions made during the derivation of the design. Specifically, these constraints impose flexure configurations with straight tips, straight roots, laterally balanced geometry, smooth curves, and low likelihood of self-collision, in addition to the planar area requirement.

With reference to FIG. 11, the shape of the flexure 18 can be parameterized using the center curve B and thickness profile—both being inputs to the optimization. The center curve B is defined using a cubic spline interpolation with end conditions. The end conditions include a zero-slope condition at both the root 40 and the extreme tip 42 of the flexure 18, while the interior control points allow precise manipulation of the shape between the two ends. During optimization, the number of control points is held constant, as well as the overall packaging format of the spring (e.g., outer radius of the flexure disk and nominal radius of the gear-like hub). With reference to FIG. 11, points (x_{edge},y_{edge}) along the boundary of the flexure area are technically defined by moving a distance of λ (equation (2)) in the direction perpendicular to the slope m of the spline at each point (x_{c}, y_{c}) along the center curve:

$$[ \begin{matrix}{x}_{edge} \\ {y}_{edge}\end{matrix} ] = [ \begin{matrix}{x}_{c} \\ {y}_{c}\end{matrix} ] \pm [ \begin{matrix}1 \\ - m\end{matrix} ] sgn ( m ) \frac{λ ( {x}_{c} )}{\sqrt{{m}^{2} + 1}} . \qquad ( 13 )$$

Area is then computed numerically using a high-resolution approximation of the flexure curve.

Due to the presence of many local minima in the objective function (which complicates convergence to a global optimum), maximum run-time may be included as a user-defined input, and the optimizer may restart repeatedly from randomized initial conditions until the run-time expires. The optimization can be implemented using MATLAB's fmincon, where the computational requirements causes a several second delay to solve one set of initial conditions. The optimization has been tested using a 4-core 1.50 GHz processor, with which it has been found that setting the maximum run-time to 30 seconds allows the tool to find several viable spring designs. A final spring design can then be automatically selected from the solutions of all trials.

Several constraints ensure a feasible solution of the nonlinear optimization. These constraints use a 2D-coordinate system with x pointing radially outward (in the opposite direction from FIG. 11) from the center of the spring 14 along the nominal center of the flexure 18:
1) The x-coordinates of the number n of interior control points are constrained to be in descending order.
2) The corresponding y-coordinates are constrained to the range [−L/2, 0] or [0, L/2] for odd or even points, respectively, which forces the spline to be roughly centered about the x-axis.
3) The flexure face is constrained to have exactly the desired planar area, which is necessary to achieve desired spring performance. This is implemented by limiting the difference between the desired and actual serpentine factors (f_{s,des}, fₛ) to less than 0.001.
4) The spring is also constrained to be laterally balanced across the x-axis, which ensures that the spring will have similar performance in both loading directions. This is implemented as follows, where n_{c} is the number of points along the centerline spline and y_{c,i} is the i^{th} y-coordinate along that spline:

$$\vert {\sum }_{i = 1}^{{n}_{c}} {y}_{c , i} \vert < 0. 1. \qquad ( 14 )$$

The cost function is defined to penalize a combination of the sharpness of curvature and nearness to self-collision between flexures. Eliminating sharp curves is necessary to avoid the nonlinearities associated with stress concentrations. This is achieved by penalizing high curvature along the centerline spline. Curvature K is calculated numerically and the sum of the squares of the curvature is included in the cost:

$${c}_{sharpness} = \vert {\sum }_{i = 1}^{{n}_{p}} {K}_{i}^{2} \vert . \qquad ( 15 )$$

Collision of neighboring flexures leads to premature failure of the spring, so the best spring will have a large minimum distance (dₘᵢₙ) between neighboring flexures. The minimum distance is calculated by checking the distance between every point along neighboring curves. The minimum is then stored, and its inverse is added to the cost, making small distances expensive:

$${c}_{nearness} = \frac{1}{{d}_{min}} . \qquad ( 16 )$$

The total cost is then calculated as a weighted sum of cₛₕₐᵣₚₙₑₛₛ and cₙₑₐᵣₙₑₛₛ.

FIG. 12 is an illustrative screen of a user interface 70 presenting input and output areas 72, 74 in an implementation of the optimization tool. The input area 72 includes required input fields 76 and optional input fields 78. The required input fields 76 are the outer radius R1 (see FIG. 1) of the spring, the thickness t of the spring, the desired spring stiffness, the design stress, and Young's modulus E for the desired spring material. The optional input fields 78 are the root radius R2 (see FIG. 1), the contact radius r, the number of flexures 18, the number of pins and pin radius (equivalent to the number of grooves 30 of FIG. 1 and their radius), the desired amount of angular deflection between the hub 12 and spring 14, and the maximum run time as noted above. The output area 104 includes a plan view image of a generated spring design 14* on an x-y coordinate chart along with two output fields 110, including allowable deflection and flexure closeness for the illustrated spring design. The 2D-spring profile can be output as Cartesian (x, y, z) points in a .txt file, which can be imported to CAD software and extruded to achieve a full 3D-model. The optimization tool was used to design the springs in the following experimental examples.

### Experimental Examples

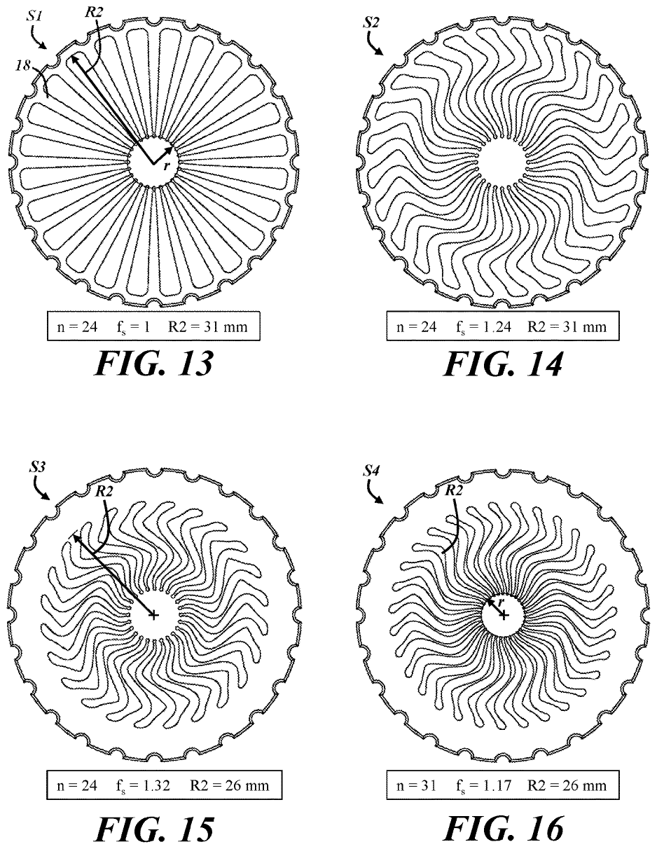

The optimization tool was used to generate four different flexure geometries and configurations having the same spring rate, and four corresponding springs S1-S4 were fabricated based on those geometries, which are illustrated in FIGS. 13-16. The four springs intentionally employ different serpentine factors and root radii R2 to simulate springs 14 with a smaller outer ring diameter to highlight the impact of the flexure 18 geometry on spring stiffness and energy storage capacity. The springs designed and fabricated are listed below in TABLE I, along with some of their design parameters:

TABLE I

| | Spring | Desired | | | | | | |
|---|---|---|---|---|---|---|---|---|
| | Rate | Deflec- | Mass | R2 | r | Flex- | | |
| | (Nm/rad) | tion (rad) | (g) | (mm) | (mm) | ures | fₛ | f_{d} |
| S1 | 150 | 0.220 | 57.3 | 31.0 | 6.0 | 24 | 1.00 | 0.40 |
| S2 | 150 | 0.253 | 71.0 | 31.0 | 6.0 | 24 | 1.24 | 0.53 |
| S3 | 150 | 0.211 | 51.8 | 26.0 | 6.0 | 24 | 1.32 | 0.53 |
| S4 | 150 | 0.234 | 60.1 | 26.0 | 5.1 | 31 | 1.17 | 0.64 |

Spring S1 was designed with 24 straight flexures (fₛ=1) with a root radius R2 of 31 mm and serves as a baseline comparison for the other three designs.

Spring S2 was designed with 24 flexures with a root radius R2 of 31 mm and a moderate serpentine factor of 1.24 to demonstrate the increased allowable deflection of serpentine flexures when compared to the straight flexures of S1.

Spring S3 was designed with 24 flexures with a root radius R2 of 26 mm and a relatively high serpentine factor of 1.32 to demonstrate how serpentine flexures can provide performance similar to that of straight flexures within a smaller enclosed volume—i.e., the root radius is about 16% smaller than that of S1 and S2.

Spring S4 was designed with 31 flexures with the smaller root radius R2 of S3 and a relatively low serpentine factor of 1.17 to demonstrate the combined effect of using serpentine flexures after optimizing the number of flexures and the flexure-cam contact radius r for maximum deflection. The contact radius r is 5.1 mm.

All four springs S1-S4 were fabricated from hardened 420 stainless steel, and each was designed with a target spring rate of 150 Nm/rad, a spring thickness of 4.5 mm, and an outer radius of 33.5 mm to interface with the spring housing.

The “design stress” input for all four spring designs was 912 MPa, which was based on S-N curve data for SS 420 material with a target endurance of roughly 100,000 alternating cycles under full load. The mass of the springs listed in TABLE I are calculated based on a 2.5 mm outer ring for all designs.

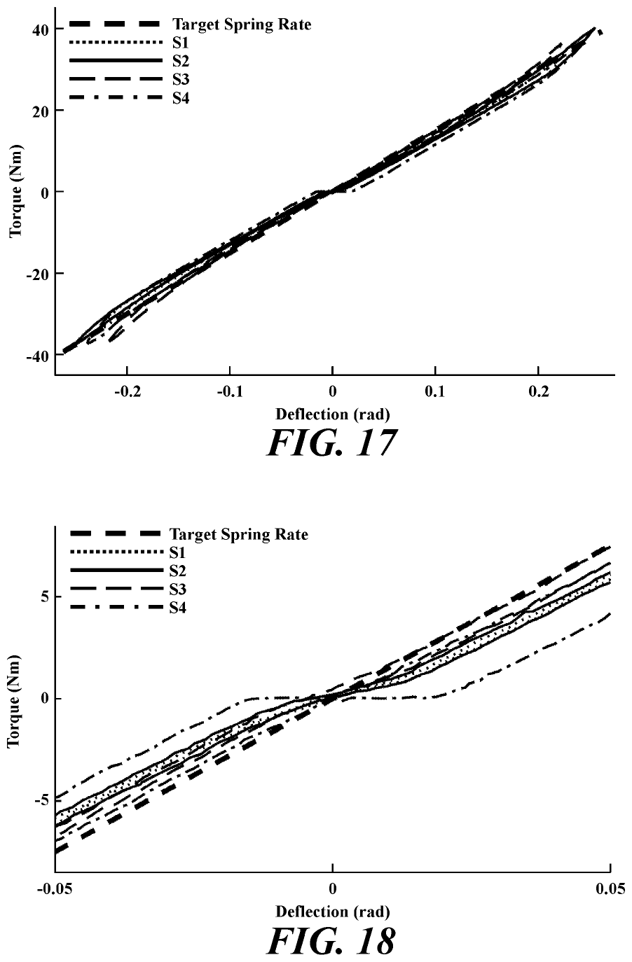

Torque-deflection behavior was evaluated for each of the fabricated springs S1-S4. Starting at the equilibrium position, each spring was loaded in one rotational direction to an angular deflection of two degrees (0.035 radians) and unloaded back to equilibrium, then loaded in the opposite rotational direction to the same angular deflection and unloaded back to equilibrium. This was repeated with sequential increases in the angular deflection of 1-2 degrees until deflections beyond the “desired deflection” input of the optimization tool were reached. As shown in FIG. 17, each spring S1-S4 achieved its designed deflection limit without signs of failure, and the measured spring rates closely aligned with the target spring rate of 150 Nm/rad. FIG. 18 is an enlarged view of the central 0.1 radians of FIG. 17. As shown in TABLE II, the measured spring rate was within 7% of the intended value for all four springs S1-S4.

TABLE II

| | Spring Rate (Nm/rad) | | | | | |
|---|---|---|---|---|---|---|
| | Loading Direction | | Unloading Direction | | | |
| | Pos. | Neg. | Pos. | Neg. | Average | Error (%) |
| S1 | 149.2 | 150.9 | 139.4 | 139.9 | 144.9 | 3.43 |
| S2 | 158.0 | 151.4 | 144.1 | 142.4 | 149.0 | 0.68 |
| S3 | 156.6 | 171.5 | 152.1 | 159.9 | 160.0 | 6.68 |
| S4 | 147.7 | 155.8 | 145.2 | 147.4 | 149.0 | 0.65 |

Energy loss due to hysteresis was quantified for each spring as well as shown in TABLE III. At the designed angular deflection, the energy loss was approximately 4-5% for springs S1-S3, while higher for spring S4. However, at smaller deflections, those percentages are significantly lower. The hysteresis may be related to friction at the spring-hub interface, which may partly explain the larger energy loss with an increased number of flexures.

TABLE III

| | Energy Loss at | Energy Loss at |
|---|---|---|
| | Max Deflection | 0.16 radians |
| | (%) | (%) |
| S1 | 3.77 | 2.30 |
| S2 | 5.36 | 2.40 |
| S3 | 4.82 | 0.84 |
| S4 | 13.01 | 2.09 |

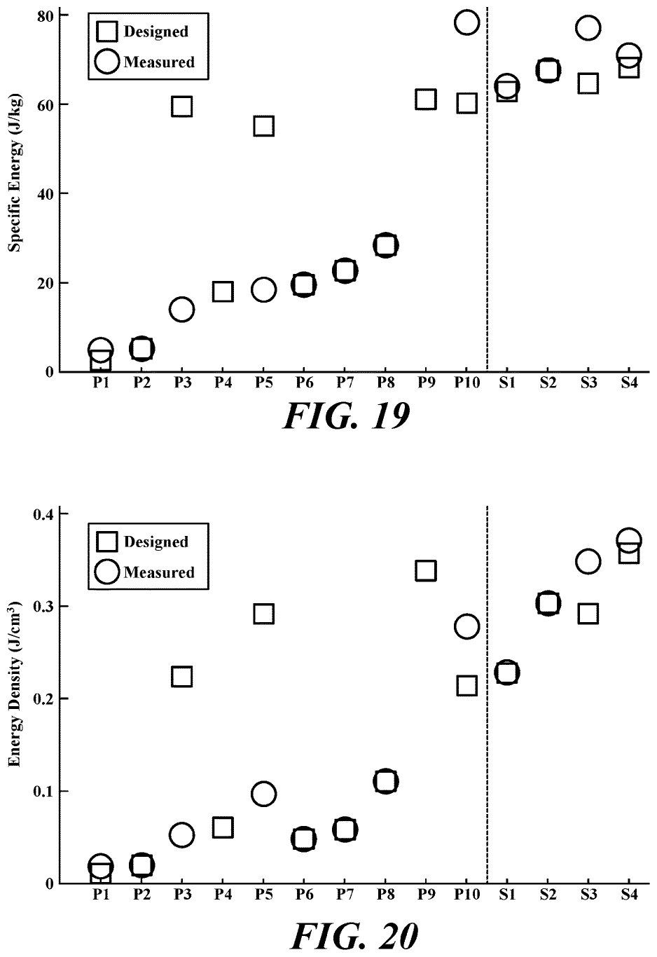

The above described spring and spring system are particularly suitable in prosthetic and other robotic applications such as the Open-Source Leg (http://opensourceleg.com) by enabling series elasticity of the joints without increasing their size. The implementation of a free end of a radially inwardly extending cantilever, serpentine-shaped flexures, and/or tapered flexures results in torsional springs having exceptional specific energy and energy density characteristics, as illustrated in FIGS. 19 and 20. FIGS. 19 and 20 chart the specific energy and energy density of ten prior art torsional spring designs P1-P10 from the years 2009-2019 alongside the four spring designs S1-S4 of FIGS. 13-16, both as designed and as measured, where the historical data is available. With one exception (P10), the prior art springs P1-P10 were unable to achieve a measured specific energy of 30 J/kg, while all of the springs S1-S4 made in accordance with the above description achieved specific energies in a range from 60 J/kg to 80 J/kg. Similarly, with the exception of P10, the prior art springs P1-P10 were unable to achieve a measured energy density greater than 0.11 J/cm³, while all of the springs S1-S4 made in accordance with the above description achieved energy densities in a range from 0.23 J/cm³ to 0.38 J/cm³.

The spring design is highly customizable and easily implemented, making it suitable for a broad range of applications. Immediate areas of impact will likely include series and parallel elastic actuators and other mechanisms in which torsional compliance is desirable. The unique combination of compactness and high energy storage make the spring particularly useful in systems that prioritize low mass and volume (e.g., wearable robotic systems, including exoskeletons and prostheses). But it is also relevant in serial-link manipulators, humanoids, and other mobile robots where mass and volume are design-driving factors.

As an example of the potential impact of the above-described approach, comparisons were made with five different prior art torsional spring designs used in five different powered mobile robots, including a lower-limb rehabilitation exoskeleton, an upper-limb rehabilitation exoskeleton, a lower-limb robotic orthosis, a planar bipedal robot, and a humanoid robot. In each case, the above-described optimization tool was used to redesign the prior art spring using the spring rate and deflection associated with those springs as inputs. As shown in TABLE IV, the optimization tool provided a spring design that was lower in both mass and volume than the original spring. None of the original designs implemented flexures with free ends.

TABLE IV

| | | Spring | | | | | | |
|---|---|---|---|---|---|---|---|---|
| | | Rate | | Mass | OD | Thickness | % Improved | |
| Application | Spring | (Nm/rad) | Deflection | (g) | (mm) | (mm) | Mass | Vol |
| Lower | Original | 353 | 0.283 | 235 | 75 | 15 | 12 | 42 |
| Limb Exo | Redesign | | | 206 | 70 | 10 | | |
| Upper | Original | 150 | 0.332 | 150 | 60 | 10 | 14 | 10 |
| Limb Exo | Redesign | | | 129 | 60 | 9 | | |
| Lower | Original | 250 | 0.240 | 370 | 90 | 23.5 | 78 | 90 |
| Limb Ortho | Redesign | | | 79.9 | 76 | 3.2 | | |
| Planar | Original | 150 | 0.262 | 150 | 67 | 25 | 35 | 78 |
| Bipedal Bot | Redesign | | | 97.5 | 50 | 10 | | |
| Humanoid | Original | 344 | 0.087 | 45.1 | 33.6 | 3.1 | 53 | 65 |
| Bot | Redesign | | | 21.2 | 20 | 3.1 | | |

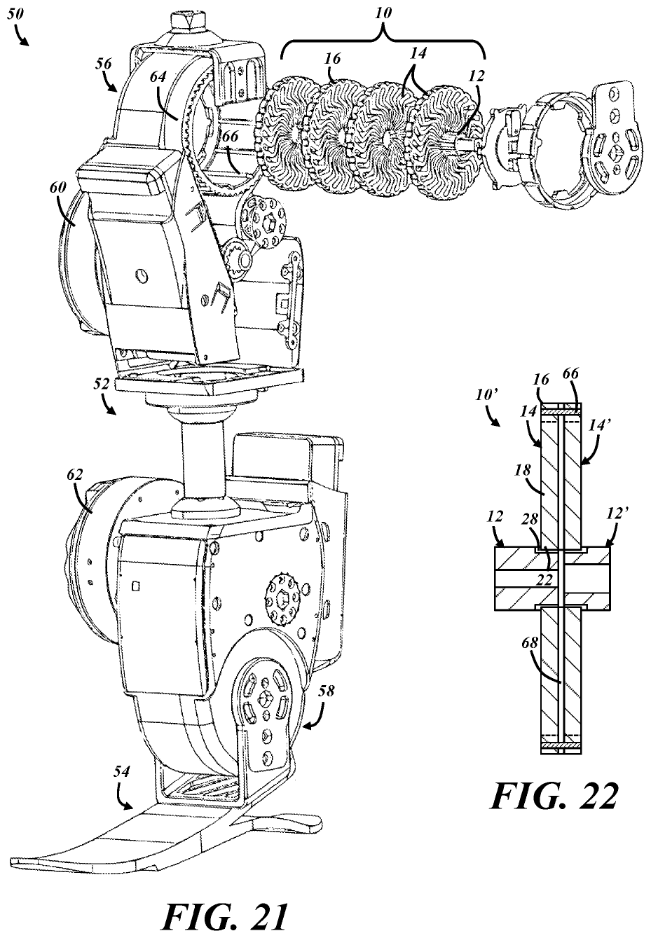

FIG. 21 illustrates one application of the above-described spring 14 and spring system 10 in a robotic device 50. This example is a powered knee-ankle prosthesis 50 including a leg portion 52, a foot portion 54, a knee joint 56, and an ankle joint 58. A first actuator 60 (e.g., an electric motor) provides controlled torque about the knee joint 56, and a second actuator 62 provides controlled torque about the ankle joint 58. A first spring system 10 is contained in a housing 64, where the outer rings 16 of a plurality of springs 14 are fixed with respect to the housing by pins 66, and a central hub 12 operatively engages with the free ends of the cantilevered spring flexures, thereby providing a compliant coupling between the actuator 60 and the load. In this arrangement, all of the springs 14 are loaded and unloaded together on the same hub 12. A second spring system associated with the ankle joint 58 may be constructed similar to the first. In each case, torque from an output shaft of the actuator 60, 62 is transmitted to the respective housing 64 via a timing belt with the plurality of springs 14 providing a compliant coupling between the housing and the central hub 12 of the spring system.

FIG. 22 is a cross-sectional view of another arrangement of springs in a spring system 10′. For simplicity in illustration, the cross-section is taken through non-serpentine flexures 18 (e.g., as in FIG. 13) of the illustrated springs 14, 14′. In this series arrangement of springs 14, 14′, the outer rings 16 of the springs 14, 14′ are pinned together via pins 66 or otherwise affixed to one another such that the two outer rings move together. The outer rings 16 are not affixed to the housing as in the previous examples. Instead, they are allowed to move freely with respect to the housing in which they are contained. For example, a low-friction bushing (e.g., a PTFE ring) may be disposed in an annular gap between the outer rings 16 and an inner surface of the housing. An axial gap 68 is provided between the flexures 18 of the respective springs 14, 14′. The ends 22 of the respective flexures 18 extend into grooves 28 of separate hubs 12, 12′ that are moveable relative to each other such that the ends 22 of the flexures 18 of one spring 14 are not necessarily moving together with the flexures of the other spring 14′. One of the hubs 12, 12′ can be affixed to the housing (or otherwise coupled with the actuator) such that the series arrangement of springs 14, 14′provides a more compliant coupling between the housing and the other one of the hubs. Each hub 12, 12′ can be engaged with more than one spring, and the springs 14, 14′ engaged with the different hubs can be the same or different from each other.

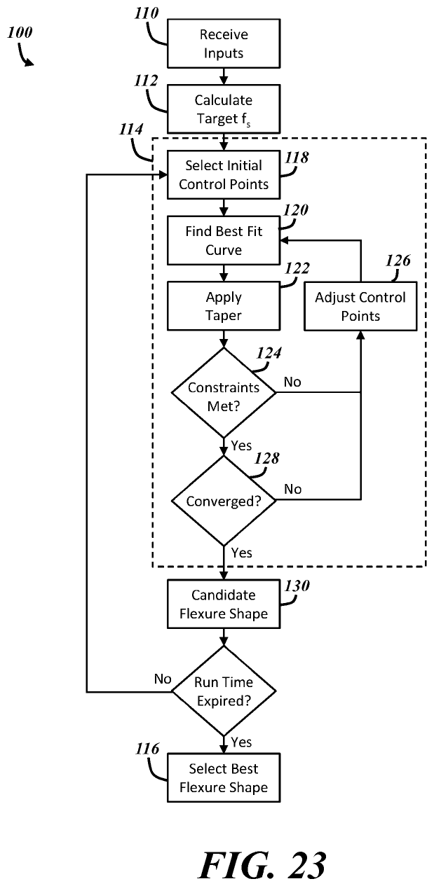

FIG. 23 is a flow chart illustrating an embodiment of the above-described optimization tool in the form of a method 100 of optimizing the shape of a flexure of the above-described torsional spring and spring system. The method includes a user inputting and/or a processor receiving spring design parameters (step 110), calculating a target serpentine factor (step 112), optimizing a flexure shape based on a set of initial control points (step 114), then repeating the optimizing step with new initial control points until a maximum run time expires before selecting a best flexure shape from the candidate flexure shapes (step 116).

The user inputs/processor receivables in step 110 may include one or more of the following spring design parameters: one or more spring dimensions (e.g., R1 of FIG. 1, t of FIGS. 8 and 10), desired spring stiffness (k), maximum design stress (Odes), and one or more spring material properties (e.g., modulus of elasticity E). The spring dimension(s) may be based on the available packaging constraints. The maximum design stress may be based on fatigue stress taken from a material-specific S-N curve at the desired number of cycles the spring will be expected to endure over its lifetime. The material properties may include the modulus of elasticity or one or more other properties indicative of the elastic modulus of the material from which the spring will be made. In some embodiments, the processor may receive a material type (e.g., a particular grade of stainless steel) or present a user with a list of materials to select from and use a date base to determine elastic modulus or other material properties.

The target value for the serpentine factor (fₛ) is then calculated in step 112 based on, for example, the spring design parameters of step 110 and on fₛ=Aₛₑᵣₚ/Aₙₒₘ, where Aₛₑᵣₚ is given as a function of spring design parameters in equation (12) above.

The optimizing step 114 includes several sub-steps, including selecting initial control points (step 118), fitting a curve to the control points (step 120), determining a flexure shape by applying a taper (step 122), checking constraints (step 124) and adjusting the control points (step 126) if the constraints are not met, checking for convergence (step 128) and adjusting the control points if parameters are not yet optimized, arriving at an optimized candidate flexure shape (step 130), and repeating step 114 if any run time remains to arrive at additional optimized candidate shapes.

The step of selecting initial control points may include selection of at least three initial control points, including the end points 40, 42 (FIG. 11) and at least one other control point (x_{c}, y_{c}) from a range of x-y points. There are preferably two or three initial control points in addition to the endpoints. The x-range (in the direction of extension of the flexure from the outer ring) is fixed by the maximum radial length L of the flexure, and the y-range may be a function of the x-range. In one embodiment, the y-range is a multiple of L, such as ±0.5L. The control points other than the endpoints may be selected randomly from within the established ranges, or one or more other constraints may be placed on selection of the initial control points (e.g., spacing along the x-axis, forced selection of two point on opposite sides of a central axis between the endpoints, etc.)

Upon selection of the initial control points, a best-fit curve is generated with appropriate boundary conditions at the end points in step 120. One example of a best fit curve is a cubic spline. A taper is then superimposed with the cubic spline as the centroid of the flexure using equation (2), for example, thereby defining a planar shape. That planar shape is evaluated in step 124 against certain constraints, including the serpentine factor calculated in step 112. The planar shape may also be evaluated for lateral (y) balance with respect to a nominal straight axis between the endpoints of the spline. If those constraints are not met within a tolerance range, the planar shape is an invalid solution, in which case the control points are adjusted to try to achieve a valid solution in another iteration. If the planar shape is a valid solution, optimization of that shape is initiated at step 128.

Optimization includes adjusting the control points in a direction that moves the solution toward a maximum or minimum value of a spring parameter, evaluating whether the new solution is optimized (converged) via comparison with the previous solution, and iterating the control points until the solution converges. The spring parameters being optimized in this case are flexure curvature (equation 15) and distance between adjacent flexures (equation 16). The curvature is minimized and/or the distance between flexures is maximized. Once the comparison at step 128 can no longer be improved upon, the resulting planar shape is logged as an optimized candidate flexure shape. If additional run time remains, the process is repeated starting with the selection of a new set of initial control points. The iterative steps 124-128 may be performed via commercially available code, such as MATLAB's fmincon.

Once the run time expires, the resulting optimized candidate flexure shapes are evaluated, and a best flexure shape is selected in step 116. Selection of the best of the candidate flexure shapes may be based on the same parameters optimized during step 114—i.e., based on the candidate flexure shape having the best combination of low curvature and high spacing among flexures.

The method may additionally include periodically replicating rotated versions of the best flexure shape about an axis near the free end of the flexure, then interconnecting the flexures with arcs centered on the axis and fillets interconnecting the arcs with side walls of the flexures. A profile of the outer ring can be added with pin-sized grooves as shown in the graphic of FIG. 12. An output file can be generated based on the resulting spring shape, which can be extruded as a solid model in conventional CAD programs to generate data file from which the spring can be machined, 3D-printed, or otherwise fabricated.

In various embodiments, a system for designing a torsional spring includes at least one processor and memory (implemented as one or more non-transitory computer-readable mediums) storing or having instructions that, when executed by the at least one processor, cause the system to perform one or more of the above-described method steps and/or one or more method steps based on or derivable from the above-discussed torsional spring or spring system.

It is to be understood that the foregoing description is of one or more preferred example embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A torsional spring comprising a ring and a cantilevered flexure extending radially inward from the ring to a free end, the free end being configured to follow a cam surface of a concentrically rotating hub to bend the flexure.

2. The torsional spring of claim 1, wherein the free end has a bulbous shape.

3. The torsional spring of claim 1, wherein the free end has a circular profile.

4. The torsional spring of claim 1, wherein the flexure is one of a plurality of cantilevered flexures each extending radially inward from the ring to a respective free end configured to follow a respective cam surface of the concentrically rotating hub to bend each flexure.

5. The torsional spring of claim 1, wherein the flexure is tapered.

6. The torsional spring of claim 1, wherein the flexure has a serpentine shape.

7. The torsional spring of claim 1, wherein the ring and flexure are monolithic.

8. The torsional spring of claim 1, wherein a stiffness of the spring is linear.

9. The torsional spring of claim 1, wherein a stiffness of the spring is the same in opposite directions of deflection.

10. The torsional spring of claim 1, wherein the spring is operable in an angular deflection range of greater than ±5 degrees.

11. A spring system comprising the torsional spring of claim 1 and a concentric hub configured to rotate with respect to the ring, the hub comprising a body and a projection extending radially outward from the body, wherein the projection includes the cam surface.

12. The spring system of claim 11, wherein the cantilevered flexure is one of a plurality of cantilevered flexures each extending radially inward from the ring to a respective free end and the projection is one of a plurality of projections each extending radially outward from the body, each projection having a cam surface, and each free end being configured to follow a respective cam surface when the hub rotates relative to the ring.

13. The spring system of claim 12, wherein the cam surfaces of an adjacent pair of the projections at least partially define a groove in the hub, and wherein one of the free ends is received in the groove.

14. The spring system of claim 13, wherein the cam surfaces of the adjacent pair of projections are non-parallel.

15. The spring system of claim 13, wherein the cam surfaces are symmetric with respect to a plane bisecting the groove.

16. A spring system comprising concentric first and second torsional springs according to claim 1 in a series arrangement.

17. A robot comprising a joint and the torsional spring of claim 1, wherein the spring transmits torque from an actuator to the joint.

18. The robot of claim 17, wherein the robot is a powered prosthesis and the joint is an ankle joint or a knee joint.

19. A method of optimizing the shape of the flexure of the torsional spring of claim 1, the method comprising iterative minimization of a curvature of the flexure and/or iterative maximization of a spacing between adjacent flexures of the spring.

20. The method of claim 19, wherein one or more of the following spring parameters is provided as a constraint: a dimension of the spring, a material property of a spring material, a spring stiffness, and a maximum design stress.
